(19) United States
(12) Patent Application Publication
(10) Pub. No.: US 2014/0112736 A1
(43) Pub. Date: Apr. 24, 2014

(54) ELEMENT FOR MANUFACTURING A BINDING FOLDER OR A DISPLAY BOARD AND METHOD THAT MAKES USE OF SUCH AN ELEMENT FOR MANUFACTURING THE BINDING FOLDER OR THE DISPLAY BOARD

(71) Applicant: Guido Peleman, Antwerpen (BE)

(72) Inventor: Guido Peleman, Antwerpen (BE)

(73) Assignee: UNIBIND LIMITED, Nicosia (CY)

(21) Appl. No.: 14/126,113

(22) PCT Filed: Jun. 11, 2012
(86) PCT No.: PCT/IB2012/001135

§ 371 Date: Dec. 13, 2013

(30) Foreign Application Priority Data
Jun. 14, 2011 (BE) 2011/0357

(51) Int. Cl. B42D 3/00

(52) U.S. Cl. CPC B42D 3/002
USPC 412/4; 281/21.1

(57) ABSTRACT

An element for manufacturing a binding folder (19) or for manufacturing a display board, whereby the element (1) is a semi-finished product that is primarily flat and primarily formed by a support (2) that is formed by or composed of one or more flat sheets and a cover (5) that is affixed over or around this sheet or sheets (4), characterised in that on one side the support (2) is provided with a layer of hot-melt adhesive (7) that extends up to a distance (D) from the edges (8) of the support (2), and this to affix a finishing cover (12) or a poster or similar on this side of the support (2).

The present invention relates to an element for manufacturing a binding folder or a display board and a method that makes use of such an element for manufacturing the binding folder or the display board.

More specifically the invention is intended for manufacturing a binding folder, for example, consisting of a U-shaped back and two endpapers for binding a bundle of leaves, such as leaves with photographs for the realisation of a photo album.

Such an element is already known from Belgian patent No. 1.018.467 in the form of a semi-finished product from which a binding folder can be produced, and this element is primarily flat and primarily formed by a support that is formed by two flat sheet that will form the endpapers, and in between a central flat strip from which the back will be formed subsequently, and which are connected together by means of a cover that is affixed over or around these sheets and strip.

The support on the outside has a layer of hot-melt adhesive that extends to the outer surface of the support over one flat side of the support and over an edge section along the periphery of the other flat side of the support.

Because they are primarily flat, such elements are easy to store in stacks without taking up a lot of room.

These elements enable professional-looking binding folders to be made in a relatively simple way, with a personalised cover that is selected for example from a stock of covers of a diverse nature, for example with regard to material, texture, printing and similar.

For this purpose a desired cover is chosen whose dimensions are larger than the dimensions of the periphery of the element concerned, and this cover is laid on a table, after which the element, with the flat side provided with hot-melt adhesive turned downwards, is laid on the cover and then the cover is folded back over the edges along the edges of the element up to against the edge sections with hot-melt adhesive on the other side of the element.

By applying heat the cover is bonded to the element by first melting the hot-melt adhesive, after which it is all allowed to cool down in order to enable the hot-melt adhesive to solidify again.

Then by deforming the aforementioned central strip of the element, a U-shaped back is realised in which a bundle of leaves can be bound.

A disadvantage of the known elements is that the edging is laborious and requires a certain amount of skill and takes time.

Moreover the edging requires extra facilities in the device with which the elements are converted into a binding folder, which makes this device more complex and expensive and the purchase of it is only justified for a sufficiently large volume of binding folders.

The edging requires a lot of moving parts, such that the risks of failure, as well as the costs of maintenance and repair, increase.

Moreover the risk of incorrect operations hereby increases, as well as the waste arising from them due to failed binding folders.

Training for the operation of the device is thus almost essential, which causes an additional cost and recalcitrance.

In the aforementioned patent, the other side of the element can be provided with a cover that is bonded partially overlapping the folded-back edges of the first cover.

This has the disadvantage that an inconvenient thicker edge occurs at the location of the overlap of the two covers.

The purpose of the invention is to provide a solution to at least one of the aforementioned and other disadvantages.

To this end the invention concerns an element for manufacturing a binding folder, whereby the element is a semi-finished product from which a binding folder can be manufactured and which is primarily flat and primarily formed by a support that is formed by or composed of one or more flat sheets and a cover that is affixed over or around this sheet or sheets, whereby on one side the support is provided with a layer of hot-melt adhesive that extends up to a distance from the edges of the support, and this to affix a finishing cover on this side of the support that is smaller than the periphery of the support.

An advantage is that the finishing cover can be smaller than the support and that the finishing cover no longer has to be folded back around the edges of the support, and thus no adhesive has to be provided along the edges of the other side of the support.

This implies that the device to affix the finishing cover can be much simpler, and also that the operation of this device is much simpler and the training of the operator can be done much more quickly. Due to the simple operation, the risk of failures and waste is also very low.

Another advantage is that such an element can be manufactured cheaply but the finished product nevertheless creates a professional impression.

By the hot-melt adhesive being applied beforehand, it can be applied in a precise quantity, such that when affixing a finishing cover, the right quantity of adhesive is in place, without a surplus or shortage of adhesive.

Moreover, in this way the adhesive can be applied uniformly, without there being local zones with a surplus or shortage of adhesive.

Additionally a pretective covering of the adhesive layer is not needed, because this is not sticky at the normal ambient temperatures.

Because the constituent parts of the support are entirely or partially surrounded by the cover, these constituent parts always preserve their correct position with respect to one another, and thus also when the element is heated to liquefy the hot-melt adhesive in order to affix the finishing cover.

In a preferred embodiment the layer of hot-melt adhesive is sufficiently thin so that it doesn't flow out when a finishing cover is applied under pressure.

This results in achieving good adhesion despite the use of a minimal quantity of adhesive.

In practice this means that the layer is thinner than 50 micrometres.

In order to obtain sufficient adhesive strength, the layer is preferentially thicker than 20 micrometres, and is more preferably between 25 and 35 micrometres.

Preferably the layer of hot-melt adhesive is applied to the support by means of a sheet that is bonded to the support, and the side turned away from the support is provided with the layer of hot-melt adhesive concerned beforehand.

The sheet with the hot-melt adhesive can be affixed, for example, by machine using a Kolbus adhesive machine or similar during the production of the element

It is a virtue of the invention to be able to use such an element to manufacture a display board, whereby in this case the aforementioned finishing cover is a poster, for example an advertising poster, a calendar, a photograph or similar.

The present invention also relates to a method for manufacturing a binding folder or a display board, which starts with an element according to the invention as described above, and whereby, to manufacture the binding folder or the display board, a printed or unprinted finishing cover or a poster is affixed with the unprinted side covering the layer of hot-melt adhesive of the support and bonded thereto by heating the hot-melt adhesive in order to allow it to melt, and then letting it cool down again in order to enable the hot-melt adhesive to solidify again.

In a preferred variant the finishing cover is bonded to the support under pressure.

This produces an improves adhesion of the finishing cover on the support.

In order to manufacture a binding folder, additionally the central strip can be deformed into a U-shaped back, if desired.

An advantage is that this method is very user-friendly as a user does not require any skill or professional knowledge and the application of the method does not require qualified and trained personnel.

This starts, for example, with a stock of primarily flat semi-finished elements and a stock of preprinted or otherwise finishing covers or posters, whereby to form the binding folder according to choice, a combination is made from these aforementioned stocks in order to compose a binding folder or a display board according to the desire of the end user.

Optionally, on the side of the support opposite the side with the layer of hot-melt adhesive, an additional finishing cover is affixed that is provided with a hot-melt adhesive with which this additional finishing cover is affixed to the support, and then the element with the finishing cover is heated and cooled to secure the finishing cover to both sides of the support.

In order to bind a bundle of leaves in the binding folder, the element can for example be provided with an adhesive strip beforehand, or after forming the back, a ring system can be secured in the back.

For the display board, optionally a hanging system or a stand is fastened to the back of the display board in order to hang the display board or position it somewhere in an upright position.

With the intention of better showing the characteristics of the invention, a few preferred embodiments of an element according to the invention are described hereinafter by way of an example, without any limiting nature, with reference to the accompanying drawings, wherein:

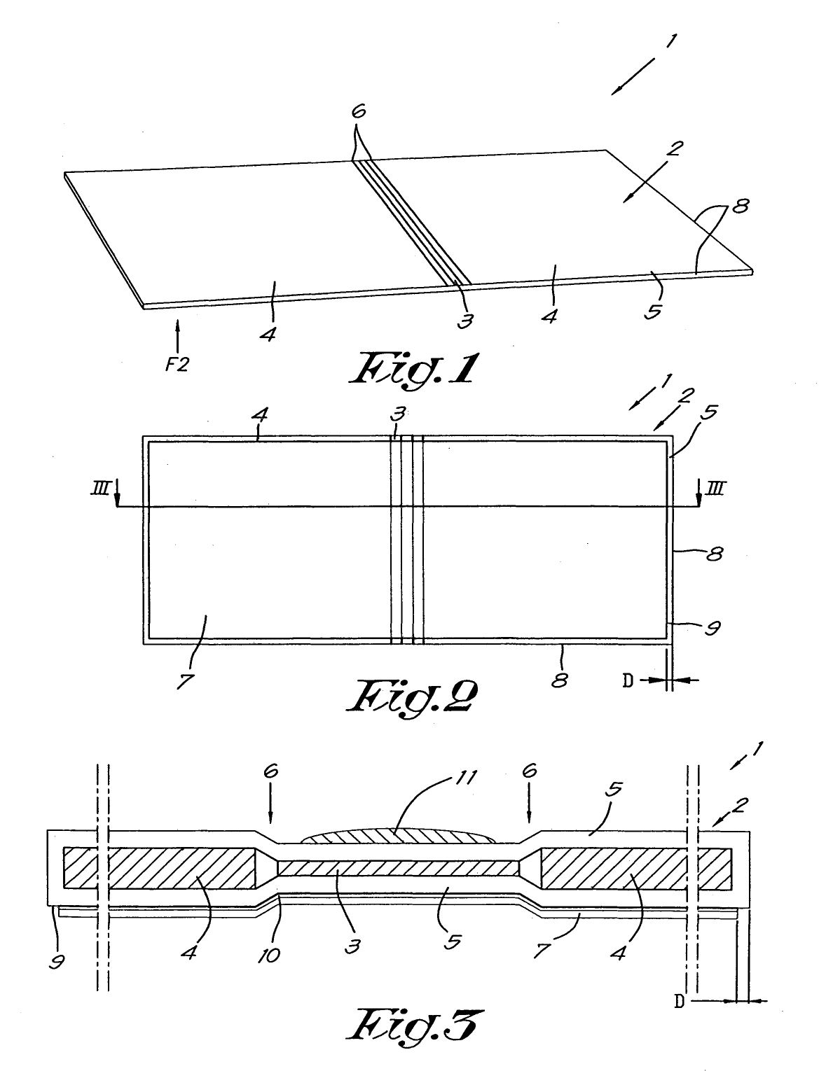

FIG. 1 shows a schematic perspective view of a practical embodiment of an element according to the invention to form a binding folder;

FIG. 2 shows a bottom view according to arrow F2 of FIG. 1;

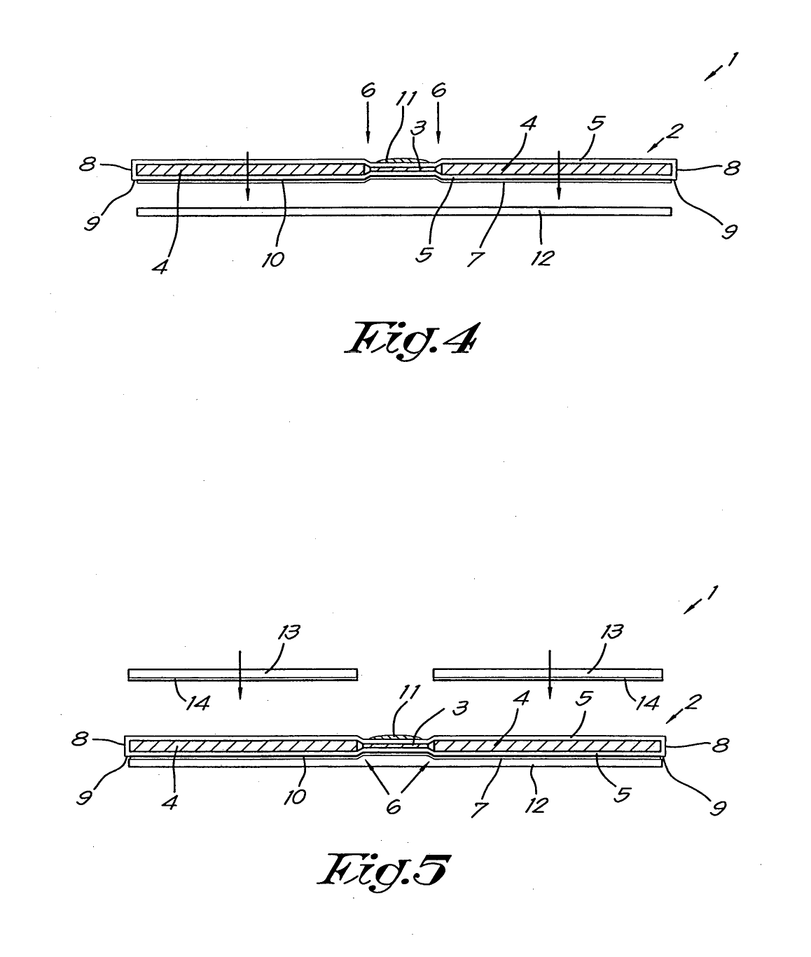

FIG. 3 shows a cross-section according to the line of FIG. 2 on a larger scale;

FIGS. 4 to 8 schematically show a few steps of the method according to the invention, making use of an element according to FIG. 1;

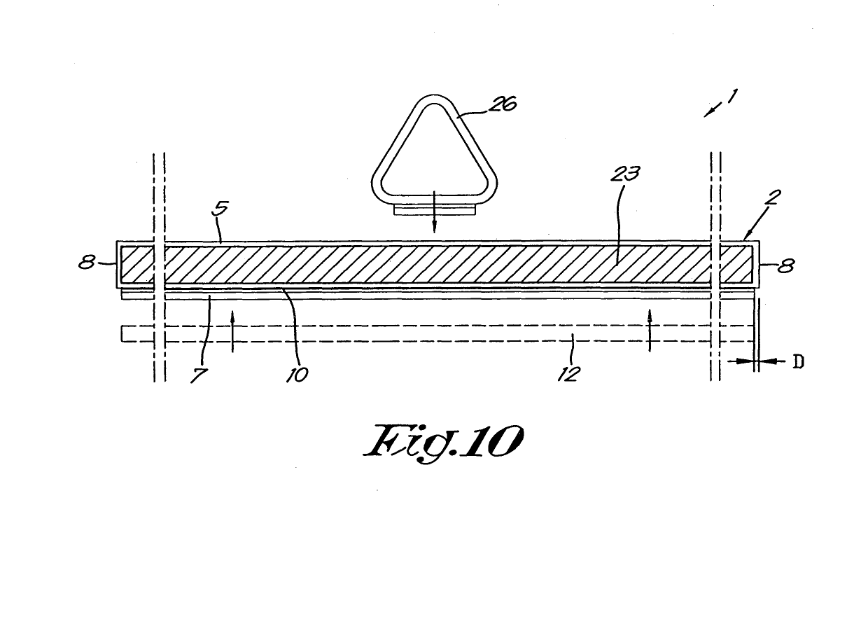

FIGS. 9 and 10 show alternative embodiments of an element according to the invention.

The element 1 according to the invention to form a binding folder shown in FIGS. 1 to 3 is a semi-finished product that primarily consists of a flat support 2 that is formed by a central flat strip 3 and two flat sheets 4 on either side of the aforementioned strip.

Furthermore, the central strip 3 is intended to later form the back of the binding folder and the two sheets 4 are intended to form the endpapers of the binding folder. In the example shown, the strip 3 is thinner than the sheets 4, but this does not necessarily have to be the case.

The support 2 has a cover 5 that is over or around the central strip 3 and sheets 4.

The cover 5 can be manufactured from paper or cardboard. However it is preferable to have a cover 5 of white, black or coloured paper, preferably paper with a density of 90 gram/m².

It goes without saying that the invention is not limited to this, and that other materials such as linen can also be used as a cover 5.

Of course it is also possible for the cover 5 to have a number of parts and that a different material is chosen for each side of the support 2, for example.

Preferably, at the location of the connection of the strip 3 with a sheet 4, the cover 5 forms a hinge 6 between these elements 3,4.

Although in the example of FIGS. 1 to 3, the sheets 4 and the central strip 3, are connected together on the top and underside by a cover 5, according to the invention it is not ruled out that the cover 5 is only on one side, and only a folded-back part of this cover 5 is folded back over the edges of the element 1 and secured to the other side of the element along the edges.

According to the invention, the support 2 is provided with a layer of hot-melt adhesive 7 on one side that extends to a distance D from the edges 8 of the support 2, all such that on the side concerned of the support 2 an edge 9 is obtained that is free of hot-melt adhesive 7.

The hot-melt adhesive 7 preferably extends to a distance D a few millimetres from the aforementioned edge 8 of the support 2, for example around two millimetres from the edge 8.

The layer of hot-melt adhesive 7 is preferably applied to the support 2 by means of a sheet 10 that is bonded to the support 2 during production of the element and that the side of the sheet 10 turned away from the support 2 is provided with the layer of hot-melt adhesive 7 concerned beforehand.

The sheet 10 with the hot-melt adhesive 7 on it is bonded to the support 2 during production, for example by means of an adhesive machine of the Kolbus® make or similar.

In a practical embodiment of the invention, the element 1 is provided with an adhesive strip 11 for the subsequent securing of a bundle of leaves in the binding folder.

In a practical embodiment of the invention, the adhesive strip 11 can be provided in the form of a strip of heat-sensitive hot-melt adhesive, and the central strip 3 is made of metal, steel or other thermally conductive material, all such that when binding the bundle of leaves the heat supplied is conducted well.

In an alternative embodiment of the invention not shown in the drawings, the adhesive strip 11 can also be in the form of a self-adhesive strip, that may or may not be protected by a thin protective sheet, and this protective layer can be easily removed by the user for binding a bundle of leaves.

The adhesive strip 11 can be applied to the cover 5 at the location of the central strip 3, or directly to the central strip 3 in the absence of a covering layer 5.

The method for manufacturing a binding folder by means of an element 1 according to the invention is very simple and is illustrated on the basis of FIGS. 4 to 7.

In a first step a desired element 1 and a suitable finishing cover are selected from a stock by the user.

The user can choose this finishing cover 12 as desired and it is clear that many materials, such as paper or cardboard, are suitable for this purpose. This finishing cover 12 can be printed beforehand or otherwise, or if desired can be printed locally. It goes without saying that other materials such as leather, linen, plastic or similar can be used as a finishing cover 8.

The finishing covers 12 have dimensions that are primarily equal to the dimensions of the periphery of the layer of hot-melt adhesive 7 on the support, all such that the finishing cover can completely cover the layer of hot-melt adhesive 7 and the finishing cover 12 extends to a few millimetres from the edge 8 of the support.

The finishing cover is then affixed with the unprinted side covering the layer of hot-melt adhesive 7, as shown in FIG. 4, and bonded thereto by heating in order to melt the hot-melt adhesive 7 and then allowing it to cool again in order to solidify the hot-melt adhesive 7.

In practice a hot-melt adhesive 7 is used whose melting temperature is lower than the temperature at which the traditionally used toner powders and printing inks are damaged, so as not to damage any print on the finishing cover.

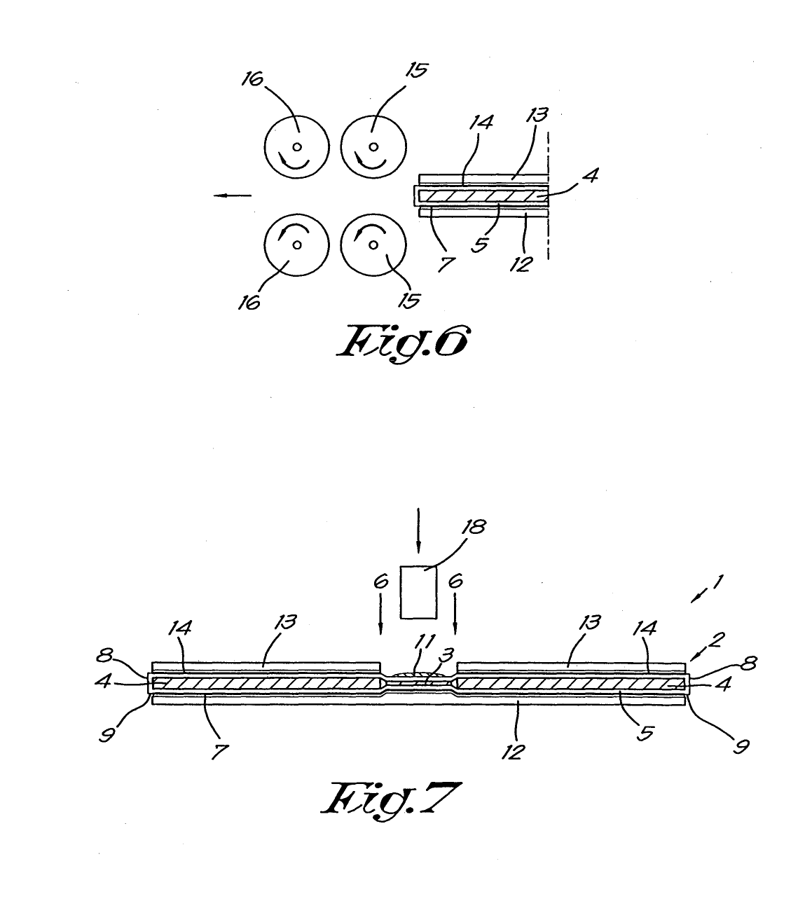

Optionally, as illustrated in FIG. 5, on the side of the support 2 opposite the side with the layer of hot-melt adhesive 7, an additional finishing cover 13 can also be applied that is provided with a hot-melt adhesive 14 with which this additional finishing cover 13 is affixed to the support 2.

By heating and cooling, this additional cover can be bonded to the support 2.

As shown in FIG. 6, the heating can be realised for example by moving the support 2 with a finishing cover 12 and/or 13 between heated rollers 15 on one or both sides of the support 2 in order to melt the hot-melt adhesive 7 and which also exert a certain pressure on the finishing cover and 13, if need be followed by cooled rollers 16 to solidify the hot-melt adhesive 7 more quickly.

During this heating operation, when there is an adhesive strip 11 of hot-melt adhesive, this adhesive strip 11 can be shielded from heat during the heating process.

If desired the finishing cover 12 and/or 13 are first provisionally secured to the support 2 by local heating at a few points to keep the finishing covers perfectly in place when they are moved between the rollers 15 and/or 16.

Alternatively, the support 2 with the finishing covers 12 and/or 13 can be pressed between two heated platens to affix the finishing covers.

In the embodiment shown, the additional finishing cover 13 is formed by two half additional finishing covers on either side of the central strip 3 of the support 2, but it is of course also possible to provide the additional finishing cover 13 in the form of one continuous additional cover, which in this case also extends over the central strip 3.

Preferably use is made of an additional finishing cover 13 whose dimensions are chosen such that the additional finishing cover 13 extends to a few millimetres from the edge 8 of the support 2, for example up to around two millimetres from the edge 8.

It is clear that in this case there are no overlaps of the covers 12 and 13 and thus a thicker edge does not occur as in the known elements, as described in the Belgian patent No. 1.018.467.

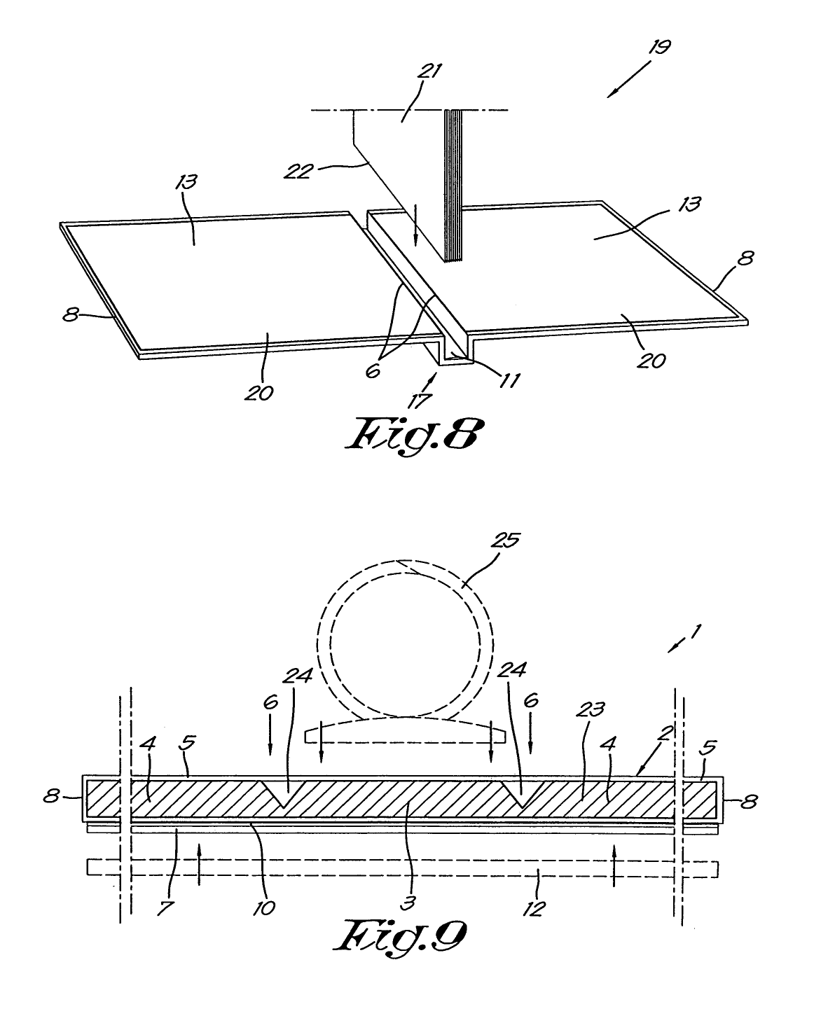

A possible last step is illustrated on the basis of FIGS. 7 and 8, whereby the central strip 3 is deformed into a U-shaped back 17, for example by means of a stamp 18.

A binding folder 19 is thus obtained, as shown in FIG. 8, with a U-shaped back 17 with an adhesive strip 11 therein and two endpapers 20.

Such a binding folder 19 can be used to bind a bundle of leaves 21 in a known way by inserting a free edge 22 of this bundle into the back 17, and heating this back 17 with suitable equipment to make the adhesive strip 11 liquid, and by pressing the edge 22 into the molten adhesive and allowing it to cool in order to solidify the adhesive again.

In an alternative embodiment of the invention, as shown in FIG. 9, the support 2 can be constructed as a continuous flat sheet 23, for example cardboard, and cutaways 24 are made in this sheet 23 to demarcate a central strip or sheet section 3 from which the back can be formed, flanked by two sheet sections 3 that will form the endpapers.

Of course it is not ruled out that a number of cutaways 24 are provided in the sheet 23.

In this example, a ring mechanism 25, instead of an adhesive strip 11, is secured to the central strip 3, with which a bundle of perforated leaves can be bound in the folder.

It is clear that a method according to the invention is within reach of everyone and thus does not require highly qualified skilled workers.

Moreover, the method enables binding folders 19 with a very professional appearance to be realised in a very flexible way, whereby it can start locally with a stock of elements 1 that can be covered according to choice with printed or unprinted finishing covers 12 to be selected from a stock, and optionally an additional finishing cover 13 also to be selected from a stock of covers 13 that are already provided with a hot-melt layer 14.

The drawings only show the invention schematically and the proportions between the different elements, primarily the thicknesses, have been drawn out of proportion, only for the purpose of being able to better explain the invention on the basis of the drawings.

FIG. 10 shows an alternative embodiment of an element 1 according to the invention, which in this case is intended for manufacturing a display board.

In this case the support 2 is formed by a single completely flat continuous sheet 23 that is provided with a cover 5, whereby in this case the support 2 is also provided with a layer of hot-melt adhesive 7 on one side that extends up to a distance D from the edges 8, and this to affix a finishing cover 12 in the form of a poster or similar on this side of the support 2.

The further method to affix a poster to the element is analogous to the method described above on the basis of FIGS. 1 to 6.

Additionally, a hanging system 26 can be fastened to the back of the display board to be able to hang the display board, or alternatively a stand not shown in the drawings in order to be able to place the display board somewhere in an upright position.

The present invention is by no means limited to the variants described as an example and shown in the drawings, but an element for manufacturing a binding folder and a method applied thereto can be realised in all kinds of variants, without departing from the scope of the invention.

1-21. (canceled)

22. Binding cover for binding a pre-bound bundle (11) of leaves, whereby the binding cover (1) is formed by a U-shaped back (2) with a base (5) and two upright arms (6-7) and flaps (3-4) attached thereto, characterised in that at least a part of the inside (12) of the back (2) is provided with a self-adhesive glue (10) in order to hold the bundle (11) in the back (2).

23. Binding cover according to claim 22, characterised in that aside from the aforementioned self-adhesive glue (10) in the back, it contains no other glue or other means to hold the bundle (11) in the binding cover (1).

24. Binding cover according to claim 22, characterised in that at least a part of the inside (12) of one or both arms (6-7) of the back (2) are provided with self-adhesive glue (10).

25. Binding cover according to claim 22, characterised in that the base (5) of the back (2) is at least partially provided with a self-adhesive glue (10).

26. Binding cover according to claim 22, characterised in that the back (5) is provided with self-adhesive glue (10) over its entire or practically entire inside (12).

27. Binding cover according to claim 22, characterised in that the self-adhesive glue (10) is covered with at least one removable protective sheet (13) that must first be removed before binding the bundle (11).

28. Binding cover according to claim 22, characterised in that the adhesive area of the glue (10) is large enough to prevent the unwanted manual detachment of the bundle (11) from the back (2) by a transverse shear force (P) being exerted on the bundle (11).

29. Binding cover according to claim 22, characterised in that the self-adhesive glue (10) is a pressure-sensitive glue.

30. Binding cover according to claim 22, characterised in that the self-adhesive glue (10) contains microspheres.

31. Binding cover according to claim 22, characterised in that the self-adhesive glue (10) contains elastomer copolymers.

32. Binding cover according to claim 22, characterised in that the back (2) is at least partly made of a flexible elastic material, so that the arms can be moved away from one another and towards one another in a reversible way.

33. Binding cover according to claim 22, characterised in that the arms (6-7) of the back (2) taper obliquely from the base (5) towards one another to form a narrow opening (8) between which the bundle (11) can be inserted.

34. Binding cover according to claim 22, characterised in that the flaps (3-4) are rigid flaps that are connected to the back (2) in a hingeable way via a fold line (9).

35. Binding cover according to claim 34, characterised in that the flaps (3-4) can be laid flat against the arms (6-7) by hinging them and are sufficiently rigid to be able open the arms (6-7) when pushed towards each other in this position.

36. Binding cover according to claim 22, characterised in that the glue (10) is covered by a protective sheet (13) having a free edge (14) to simply its removal.

37. A method of binding a pre-bound bundle (11) of sheets into a binding cover (1) which is formed by a U-shaped back (2) with a base (5) and two upright arms (6-7) and flaps (3-4) attached thereto, comprising applying a self-adhesive glue (10) to said binding cover (1).

38. The method according to claim 37, characterised in that this take place in a binding cover (1) which is shaped such that, for retaining the bundle (11) in the binding cover, the glue does not need to be able to withstand any or any significant tensile forces, but only needs to be able to withstand shear forces.

39. The method according to claim 37, characterised in that it concerns a pressure sensitive glue.

40. The method according to claim 37, characterised in that this take place on at least a part of the inside (12) of one or both arms (6-7).

41. The method according to claim 37, characterised in that this take place in a binding cover (1) of which the back (2) is at least partly made of a flexible elastic material, so that the arms (6-7) can be moved away from one another and towards one another in a reversible way.
